(19) United States
(12) Patent Application Publication
(10) Pub. No.: US 2016/0055961 A1
(43) Pub. Date: Feb. 25, 2016

(54) WIRE WOUND INDUCTOR AND MANUFACTURING METHOD THEREOF

(71) Applicant: SAMSUNG ELECTRO-MECHANICS CO., LTD., Suwon-Si (KR)

(72) Inventors: Hyun-Hee GU, Yongin (KR); Woo-Kyung SUNG, Suwon (KR); Young-Sook LEE, Suwon (KR); Byoung-Jin CHUN, Seoul (KR); Hye-Jin JEONG, Suwon (KR); Myung-Jun PARK, Hwaseong (KR); Jae-Hwan HAN, Hwaseong (KR)

(21) Appl. No.: 14/687,402

(22) Filed: Apr. 15, 2015

(30) Foreign Application Priority Data
Aug. 21, 2014 (KR) 10-2014-0108873

(51) Int. Cl. H01F 27/29; H01F 41/04

(52) U.S. Cl. CPC H01F 27/29; H01F 41/04

(57) ABSTRACT

A wire wound inductor and a manufacturing method thereof. A wire wound inductor in accordance with an aspect of the present invention includes a magnetic core, a coil being wound and installed in the magnetic core, and a conductive resin layer being formed on each of both ends of the magnetic core for electrical connection with the coil. The conductive resin layer includes a head covering a surface of the end of the magnetic core and a band being extended from the head to a lateral surface of the end of the magnetic core, and the head is formed to be relatively thinner than the band.

### CROSS-REFERENCE TO RELATED APPLICATIONS

This application claims the benefit of Korean Patent Application No. 10-2014-0108873, filed with the Korean Intellectual Property Office on Aug. 21, 2014, the disclosure of which is incorporated herein by reference in its entirety.

### BACKGROUND

1. Technical Field

The present invention relates to a wire wound inductor and a manufacturing method thereof.

2. Related Art

An inductor is a passive element configured for supplying various voltages to an integrated circuit (IC), and is usually connected to an output of a power supply to provide a stable current to the IC.

Recently, along with the rapid development of electronic and telecommunications devices, communication problems have been increased due to an interference between these frequently used devices. Accordingly, in order to improve the deteriorated electromagnetic environments that are caused by the use of these devices, tighter regulations on EMI (Electromagnetic Interference) have been increasingly introduced in each country.

Due to this trend, there has been a growing demand for developing a device capable of eliminating the EMI. Accordingly, the technology has been developed to achieve complex functionalities, high density integration, and high efficiency. Among these devices, the inductor may be mainly used in personal computers, telecommunication devices and on the like as a filter for eliminating high frequency noises.

As the electronic and telecommunications devices have increasingly become smaller and more performance-oriented, it is also required to curb the generation of heat through the use of smaller and lower-resistant parts or devices. Accordingly, studies are required to make smaller and lower-resistant inductors used in the electronic and telecommunications devices.

### SUMMARY

Embodiments of the present invention provide a wire wound inductor and a manufacturing method thereof in which a head is formed to be relatively thinner than a band in a conductive resin layer.

Here, the conductive resin layer may be formed by being coated on both ends of a magnetic core using a dipping process and then by having a portion thereof corresponding to the head removed.

### BRIEF DESCRIPTION OF DRAWINGS

FIG. 1 is a perspective view of a wire wound inductor according to one exemplary embodiment.

FIG. 2 is a cross-sectional view of the wire wound inductor according to one exemplary embodiment.

FIG. 3 is a flow diagram showing a method of manufacturing a wire wound inductor according to one exemplary embodiment.

FIG. 4, FIG. 5, FIG. 6 and FIG. 7 show main steps of the method of manufacturing a wire wound inductor according to one exemplary embodiment.

### DETAILED DESCRIPTION

Hereinafter, certain embodiments of a wire wound inductor and a manufacturing method thereof in accordance with the present invention will be described in detail with reference to the accompanying drawings. In describing the present invention with reference to the accompanying drawings, any identical or corresponding elements will be assigned with same reference numerals, and no redundant description thereof will be provided.

Terms such as “first” and “second” can be used in merely distinguishing one element from other identical or corresponding elements, but the above elements shall not be restricted to the above terms.

When one element is described to be “coupled” to another element, it does not refer to a physical, direct contact between these elements only, but it shall also include the possibility of yet another element being interposed between these elements and each of these elements being in contact with said yet another element.

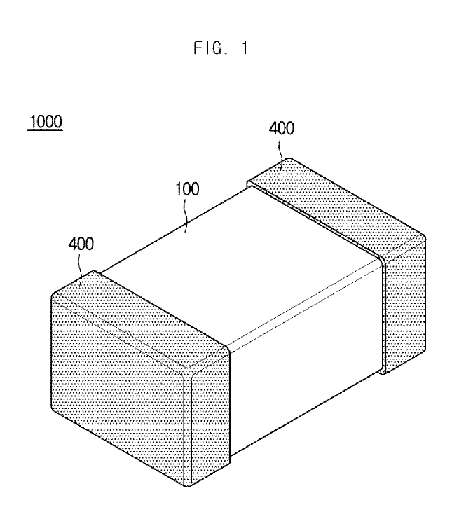

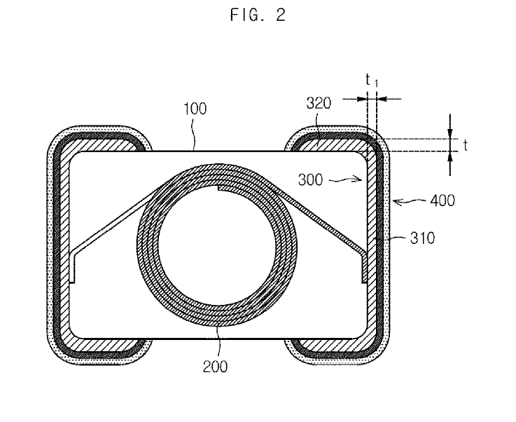

FIG. 1 is a perspective view of a wire wound inductor according to one exemplary embodiment, and FIG. 2 is a cross-sectional view of the wire wound inductor according to one exemplary embodiment.

As shown in FIG. 1 and FIG. 2, a wire wound inductor 1000 according to one exemplary embodiment includes a magnetic core 100, a coil 200 and a conductive resin layer 300, and may further include a plated layer 400.

The magnetic core 100 is a medium having a magnetic path formed therein through which magnetic flux being induced by the coil 200 when a current is applied to the coil 200 passes and may be made of magnetic alloy particles and an insulation material interposed between the magnetic alloy particles.

The magnetic core 100 may be manufactured by shaping a magnetic paste containing the magnetic alloy particles and a thermal changing insulation material at a predetermined mass ratio into a certain shape using, for example, a compression molding method and then by hardening the insulation material, for example, by heat treating the shaped paste.

The magnetic alloy particles may be Fe—Cr—Si alloy particles or Fe—Si—Al alloy particles, of which an impedance design may be readily made by composition change, with a high electrical resistance and a low magnetic flux loss, and used for the thermal changing insulation material may be an epoxy resin, a phenol resin, or polyester.

By using the insulation material such as epoxy resin, the magnetic core 100 may provide a sufficient adhesive force to the coil 200 that is installed therein.

The coil 200, which is wound and installed in the magnetic core 100, may induce a voltage in proportion to a change of current through electromagnetic induction, in which magnetic flux is induced when an electric current is applied.

As shown in FIG. 2, the coil 200 may be a flat wire coil that is wound using α-winding method. Accordingly, the wire wound inductor 1000 in one exemplary embodiment may be, but not limited to, a chip type inductor, and it shall be appreciated that the coil 200 may be configured in various forms if necessary.

The coil 200 may be made of at least one of noble metals, such as Ag, Pb, and Pt, having a superior conductivity and Ni, and Cu, or a compound having at least two of these materials.

The coil 200 may have an insulation film coated on a surface thereof. The insulation film, which is for providing insulation of the coil 200 when the wire is wound and may be made of, for example, polyurethane or polyester.

The conductive resin layer 300, which is formed at each of both ends of the magnetic core 100 for electrical connection with the coil 200, may work as external terminals for electrical connection when the wire wound inductor 1000 is mounted on, for example, a separate substrate.

Specifically, the ends of coil 200 may be extended to an outside of the magnetic core 100 and may be bonded with the conductive resin layer 300 that is formed on both ends of the magnetic core 100. Moreover, as described above, the external terminals that are constituted with the conductive resin layer 300 may be electrically connected to the separate substrate on which the wire wound inductor 1000 is installed.

The conductive resin layer 300 includes a head 310, which covers a surface of one end of the magnetic core 200, and a band 320, which extends from the head 310 to at least one of lateral surfaces of the end of the magnetic core 200. The band 320 may cover a portion of the lateral surfaces around the end of the magnetic core 300. A thickness t1 of the head 310 is relatively smaller than a thickness t2 of the band 320.

Specifically, described with respect to the direction shown in FIG. 2, the conductive resin layer 300 formed on each end of the magnetic core 100 is the head 310, and the conductive resin layer 300 formed on a top surface and a bottom surface of the magnetic core 100 is the band 320.

As the conductive resin layer 300 has a fluidity and a viscosity before being hardened, the head 310 may be formed to be thicker than the band 320 during the process of forming the conductive resin layer 300 on each end of the magnetic core 100, and a middle portion of the head 310 may be the thickest (see FIG. 5).

As a result, an overall dimension of the wound wire inductor 1000 may be increased. Moreover, the thicker the conductive resin layer 300, the lower the conductivity thereof due to a possible large volume of oxidation layer therein and the higher the DC resistance Rdc.

Accordingly, the wire wound inductor 1000 according to one exemplary embodiment may prevent the aforementioned shortcomings by forming the thickness t1 of the head 310 to be relatively smaller than the thickness t2 of the band 320 when forming the conductive resin layer 300.

In addition, the thickness t1 of the head 310 may be regulated within the range of 1 μm to 20 μm for maintaining the dimension of the wire wound inductor 1000 and for decreasing the DC resistance Rdc.

The plated layer 400, which is formed on the conductive resin layer 300 so as to cover the conductive resin layer 300, may prevent the conductive resin layer 300 from being exposed.

If the conductive resin layer 300 were exposed, a corrosion or a damage could occur. Accordingly, both the conductive resin layer 300 and the plated layer 400 may form the external terminals by having the conductive resin layer 300 covered by the plated layer 400.

In this exemplary embodiment, the plated layer 400 may be formed in, but not limited to, two layers of metal as shown in FIG. 2, and it shall be appreciated that plated layer 400 may be variously formed, for example, in one layer or three or more layers, if necessary.

The two metal layers shown in FIG. 2 may be constituted with a Ni-plated layer covering the conductive resin layer 300 and an Ag-plated layer covering the Ni-plated layer. In such a case, the Ag-plated layer, which has a relatively good conductivity, may be a layer for facilitating an electrical connection with a separate substrate, and the Ni-plated layer may be a layer for coupling the conductive resin layer 300 with the Ag-plated layer.

In the wire wound inductor 1000 according to one exemplary embodiment, the conductive resin layer 300 may be formed by mixing a thermosetting resin with a metallic filler. The conductive resin layer 300 may be formed by dispersedly mixing the highly conductive, metallic filler, such as Ag, Cu, Ni and an alloy thereof, with the thermosetting resin.

Since the thermosetting resin itself has a fluidity before being hardened, it may be easy to coat each end of the magnetic core 100 with the conductive resin layer 300, and then the conductive resin layer may be formed on each end of the magnetic core 300 by heating the conductive resin layer after the coating.

In the wire wound inductor 1000 according to one exemplary embodiment, the conductive resin layer 300 may be formed by having each end of the magnetic core 100 coated through a dipping process and then removing a portion thereof corresponding to the head 310.

In the dipping process, each end of the magnetic core 100 is coated by being dipped into the conductive resin paste. As described above, the head 310 may be formed to be relatively thicker than the band 320, and the center portion of the head 310 may be the thickest due to the fluidity and viscosity of the conductive resin paste (see FIG. 5).

Accordingly, by removing the portion corresponding to the head 310 from the conductive resin paste coated on each end of the magnetic core 100, the thickness t1 of the head 310 may be formed to be relatively smaller than the thickness t2 of the band 320.

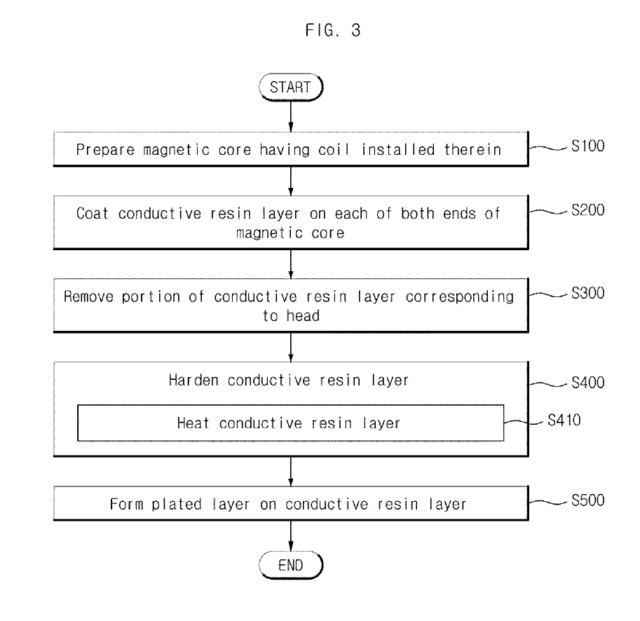

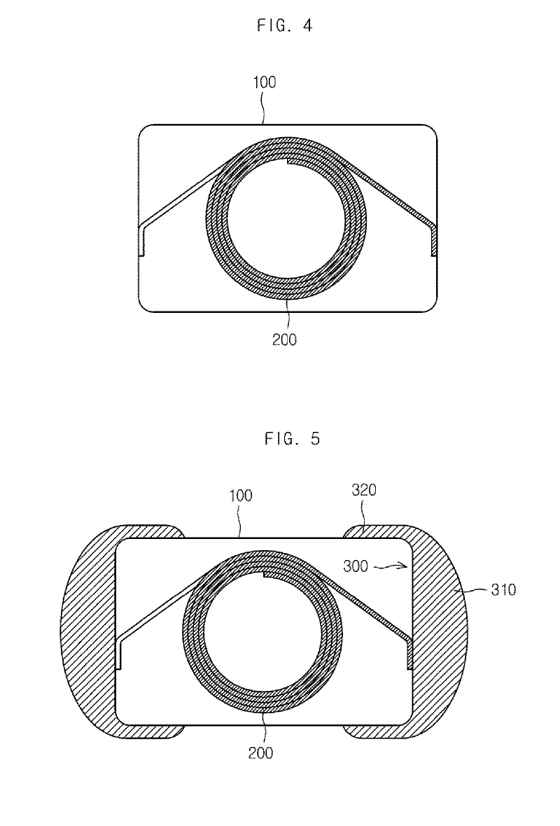

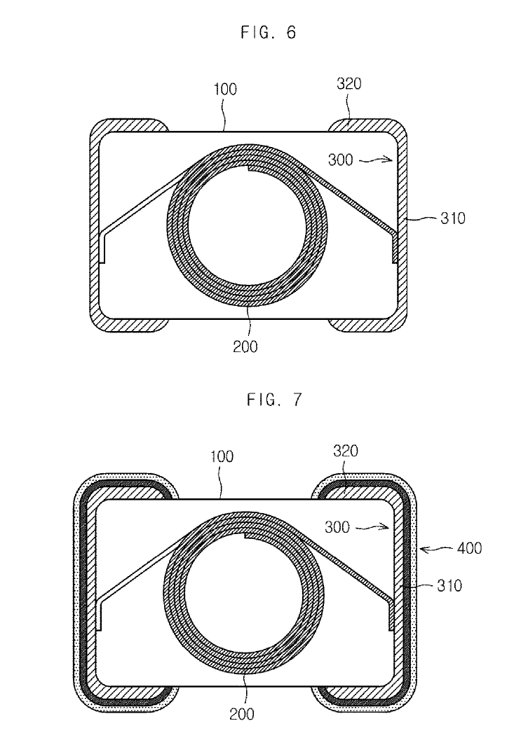

FIG. 3 is a flow diagram showing a method of manufacturing a wire wound inductor according to one exemplary embodiment, and FIG. 4, FIG. 5, FIG. 6 and FIG. 7 show main steps of the method of manufacturing a wire wound inductor according to one exemplary embodiment.

As shown in FIG. 3 to FIG. 7, the method of manufacturing a wire wound inductor according to one exemplary embodiment starts with preparing a magnetic core 100 having a coil 200 installed therein (S100, FIG. 4).

Here, the magnetic core 100 is a space having a magnetic path formed therein through which magnetic flux being induced by the coil 200 when a current is applied to the coil 200 passes and may be made of magnetic alloy particles and an insulation material interposed between the magnetic alloy particles.

The coil 200 is wound and installed in the magnetic core 100 and may induce a voltage in proportion to a change of current through electromagnetic induction, in which magnetic flux is induced when an electric current is applied.

Then, a conductive resin layer 300 is coated on each end of the magnetic core 100 (S200, FIG. 5). The conductive resin layer 300 is formed at each of both ends of the magnetic core 100 for electrical connection with the coil 200, and may work as external terminals for electrical connection when the wire wound inductor 1000 is mounted on, for example, a separate substrate.

The conductive resin layer 300 may be coated on the magnetic core 100 by dipping each end of the magnetic core 100 into the conductive resin paste using a dipping process or the like.

As shown in FIG. 5, since the conductive resin layer 300 has a fluidity and a viscosity before being hardened, the head 310 may be formed to be thicker than the band 320 during the process of forming the conductive resin layer 300 on each end of the magnetic core 100, and the center portion of the head 310 may be the thickest.

As a result, an overall dimension of the wire wound inductor 1000 may be increased. Moreover, the thicker the conductive resin layer 300, the lower the conductivity thereof due to a possible large volume of oxidation layer therein and the higher the DC resistance Rdc.

Next, a portion of the conductive resin layer 300 corresponding to the head 310 is removed (S300, FIG. 6). By removing the portion corresponding to the head 310 from the conductive resin paste coated on each end of the magnetic core 100, the thickness t1 of the head 310 may become relatively smaller than the thickness t2 of the band 320.

Accordingly, the method of manufacturing a wire wound inductor according to the present embodiment may reduce the dimension and the resistance of the wire wound inductor 1000 by forming the thickness t1 of the head to be smaller than the thickness t2 of the band 320.

After the S300 step, the method of manufacturing a wire wound inductor according to one exemplary embodiment may further include hardening the conductive resin layer 300 (S400). By allowing the conductive resin layer 300, which has some fluidity before being hardened, to be hardened, the conductive resin layer 300 may be prevented from being deformed.

The conductive resin layer 300 may be formed by mixing ea thermosetting resin with a metallic filler, and the S400 step may include heating the conductive resin layer 300 (S410). The conductive resin layer 300 may be formed by dispersedly mixing the highly conductive, metallic filler, such as Ag, with the thermosetting resin.

Since the thermosetting resin itself has a fluidity before being hardened, the conductive resin layer 300 may be readily coated on each end of the magnetic core 100, and the conductive resin layer 300 may be formed on each end of the magnetic core 300 by heating and hardening the conductive resin layer 300 after the coating.

After the S400 step, the method of manufacturing a wire wound inductor according to one exemplary embodiment may further include forming a plated layer 400 on the conductive resin layer 300 so as to cover the conductive resin layer 300 (S500, FIG. 7).

Here, the plated layer 400 is formed on the conductive resin layer 300 so as to cover the conductive resin layer 300 and may prevent the conductive resin layer 300 from being exposed.

If the conductive resin layer 300 were exposed, a corrosion or a damage could occur. Accordingly, both the conductive resin layer 300 and the plated layer 400 may form the external terminals by covering the conductive resin layer 300 with the plated layer 400.

Meanwhile, in the method of manufacturing a wire wound inductor according to an embodiment of the present invention, the main elements of the wire wound inductor 1000 in accordance with an embodiment of the present invention have been already described above, and thus any redundant description thereof will not be provide herein.

Although certain embodiments of the present invention have been described, it shall be appreciated that there can be a very large number of permutations and modification of the present invention by those who are ordinarily skilled in the art to which the present invention pertains without departing from the technical ideas and scope of the present invention, which shall be defined by the claims appended below. It shall be also appreciated that many other embodiments than the embodiments described above are included in the claims of the present invention.

What is claimed is:

1. A wire wound inductor, comprising:
a magnetic core;
a coil being wound and installed in the magnetic core; and
a conductive resin layer being formed on each of both ends of the magnetic core for electrical connection with the coil,
wherein the conductive resin layer comprises:
a head covering a surface of the end of the magnetic core; and
a band being extended from the head to a lateral surface of the end of the magnetic core, and
wherein the head is formed to be relatively thinner than the band.

2. The wire wound inductor of claim 1, further comprising a plated layer so as to cover the conductive resin layer.

3. The wire wound inductor of claim 1, wherein the conductive resin layer is formed by mixing a thermosetting resin with a metallic filler.

4. The wire wound inductor of claim 1, wherein the conductive resin layer is formed by being coated on each of both ends of the magnetic core through a dipping process and then having a portion thereof corresponding to the head removed.

5. A method of manufacturing a wire wound inductor, comprising:
preparing a magnetic core having a coil installed therein;
coating a conductive resin layer on each of both ends of the magnetic core; and
removing a portion of the conductive resin layer corresponding to a head.

6. The method of claim 5, further comprising, after the removing of the conductive resin layer corresponding to a head, hardening the conductive resin layer.

7. The method of claim 6, wherein the conductive resin layer is formed by mixing a thermosetting resin with a metallic filler, and
wherein the hardening of the conductive resin layer comprises heating the conductive resin layer.

8. The method of claim 6 further comprising, after the hardening of the conductive resin layer, forming a plated layer covering the conductive resin layer.
